(19) United States
(12) Patent Application Publication
(10) Pub. No.: US 2019/0256094 A1
(43) Pub. Date: Aug. 22, 2019

(54) ARCHITECTURE AND METHODOLOGY FOR TARGET STATES DETERMINATION OF PERFORMANCE VEHICLE MOTION CONTROL

(71) Applicant: GM GLOBAL TECHNOLOGY OPERATIONS LLC, Detroit, MI (US)

(72) Inventors: SeyedAlireza Kasaiezadeh Mahabadi, Shelby Township, MI (US); James H. Holbrook, Fenton, MI (US); Hualin Tan, Novi, MI (US); John R. Yost, Southfield, MI (US); Xueying Kang, Novi, MI (US); Bakhtiar B. Litkouhi, Washington, MI (US)

(21) Appl. No.: 15/902,625

(22) Filed: Feb. 22, 2018

(51) Int. Cl. B60W 30/182; B60W 30/18

(52) U.S. Cl. CPC B60W 30/182; B60W 30/1819; B60W 30/18009

(57) ABSTRACT

A vehicle, system and a method of driving a performance vehicle. The system includes a sensor for detecting a value of driver input to the vehicle, and a processor. The processor is configured to compare the value of the driver input to a threshold value for the driver input, switch to a performance mode operation for the vehicle when the value of the driver input is greater than the threshold value, generate a command at the vehicle based on the value of the driver input using a performance model of the vehicle activated in the performance mode, and activate a performance actuator of the vehicle to generate a dynamic parameter at the vehicle from the command.

### INTRODUCTION

The subject disclosure relates to driver-assisted performance vehicles and, in particular, a method and system of switching between a standard mode and a performance mode for operating performance vehicles.

In standard driving conditions, a Driver Command Interpreter (DCI) is used to receive driver commands, such as a steering wheel angle (SWA), that generate dynamic parameters at the vehicle, such as a target yaw rate and lateral velocity. The DCI operates actuators to implement actions at the vehicle to achieve these dynamic parameters. The DCI generally uses a steady state model of the vehicle that assumes a linear tire model.

A performance vehicle is a vehicle that is designed and constructed specifically for speed. Performance vehicles are often driven outside of the linear range that define the driving experience of standard vehicles. Additional actuators are generally used in operating a performance vehicle that are not used in standard vehicles. In a driver-assisted performance vehicle, it is useful to be able to determine when the vehicle is being driven outside of the linear range so that the additional actuators can be activated. Accordingly, it is desirable to provide a system and mode for determining when a vehicle is to be driven in a standard mode of operation and a performance mode of operation.

### SUMMARY

In one exemplary embodiment, a method of operating a performance vehicle is disclosed. The method includes detecting a driver input at the vehicle, comparing a value of the driver input to a threshold value for the driver input, switching to a performance mode of operation for the vehicle when the value of the driver input is greater than the threshold value, generating a command at the vehicle based on the value of the driver input using a performance model of the vehicle activated in the performance mode, and activating a performance actuator of the vehicle to generate a dynamic parameter at the vehicle from the command.

In addition to one or more of the features described herein, the driver input includes at least one of an accelerator pedal position and a brake pedal position. The driver input may further include a steering wheel angle.

In addition to one or more of the features described herein, the method further includes switching to the performance mode of operation when a lateral acceleration, a brake pedal position and a steering wheel angle exceed their respective threshold values, as well as switching to a standard mode of operation of the vehicle when one of the lateral acceleration is less than a lateral acceleration threshold value, and the brake pedal position is less than a brake pedal position threshold and the steering wheel angle is less than a steering wheel angle threshold. The dynamic parameter is at least one of a desired yaw rate and a desired side slip angle at the vehicle.

In addition to one or more of the features described herein, determining the dynamic parameter of the vehicle in the performance mode uses a tractive torque on a tire related to the accelerator pedal position and a braking torque on the tire related to the brake pedal position.

In another exemplary embodiment, a system for operating a vehicle is disclosed. The system includes a sensor for detecting a value of driver input to the vehicle, and a processor. The processor is configured to compare the value of the driver input to a threshold value for the driver input, switch to a performance mode of operation for the vehicle when the value of the driver input is greater than the threshold value, generate a command at the vehicle based on the value of the driver input using a performance model of the vehicle activated in the performance mode, and activate a performance actuator of the vehicle to generate a dynamic parameter at the vehicle from the command.

In addition to one or more of the features described herein, the driver input includes at least one of an accelerator pedal position and a brake pedal position. In addition, the driver input may include a steering wheel angle.

In addition to one or more of the features described herein, the processor is further configured to switch to the performance mode of operation when a lateral acceleration, a brake pedal position and a steering wheel angle exceed their respective threshold values. The processor is further configured to switch to a standard mode of operation of the vehicle when one of the lateral acceleration is less than a lateral acceleration threshold value, and the brake pedal position is less than a brake pedal position threshold and the steering wheel angle is less than a steering wheel angle threshold. The dynamic parameter is at least one of a desired yaw rate and a desired side slip angle at the vehicle.

In addition to one or more of the features described herein, determining the dynamic parameter of the vehicle in the performance mode uses a tractive torque on a tire related to the accelerator pedal position and a braking torque on the tire related to the brake pedal position.

In yet another exemplary embodiment, a vehicle is disclosed. The vehicle includes a sensor for detecting a value of driver input to the vehicle, and a processor. The processor is configured to compare the value of the driver input to a threshold value for the driver input, switch to a performance mode of operation for the vehicle when the value of the driver input is greater than the threshold value, generate a command at the vehicle based on the value of the driver input using a performance model of the vehicle activated in the performance mode, and activate a performance actuator of the vehicle to generate a dynamic parameter at the vehicle from the command.

In addition to one or more of the features described herein, the driver input includes at least one of an accelerator pedal position and a brake pedal position. In addition, the driver input may include a steering wheel angle.

In addition to one or more of the features described herein, the processor is further configured to switch to the performance mode of operation when a lateral acceleration, a brake pedal position and a steering wheel angle exceed their respective threshold values. The processor is further configured to switch to a standard mode of operation of the vehicle when one of the lateral acceleration is less than a lateral acceleration threshold value, and the brake pedal position is less than a brake pedal position threshold and the steering wheel angle is less than a steering wheel angle threshold.

In addition to one or more of the features described herein, the dynamic parameter is at least one of a desired yaw rate and a desired side slip angle at the vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle including an associated trajectory planning system in accordance with various embodiments;

FIG. 2 shows a top view of the vehicle illustrating various forces on the vehicle during a maneuver;

FIG. 3 shows a control structure for operating the vehicle in a driver-assisted mode;

FIG. 4 shows a flowchart for making a decision selecting a mode of operation for the vehicle, i.e., selecting either the standard mode or the performance mode;

FIG. 5 shows a schematic diagram illustrating a method for determining target states for performing driving or operation in a performance mode;

FIG. 6 shows a graph comparing target yaw rates from standard models and performance models of the vehicle; and

FIG. 7 shows a time graph illustrating a switching of the vehicle from between a standard mode and performance mode using the decision methods of FIG. 4.

### DETAILED DESCRIPTION

The following description is merely exemplary in nature and is not intended to limit the present disclosure, its application or uses. It should be understood that throughout the drawings, corresponding reference numerals indicate like or corresponding parts and features.

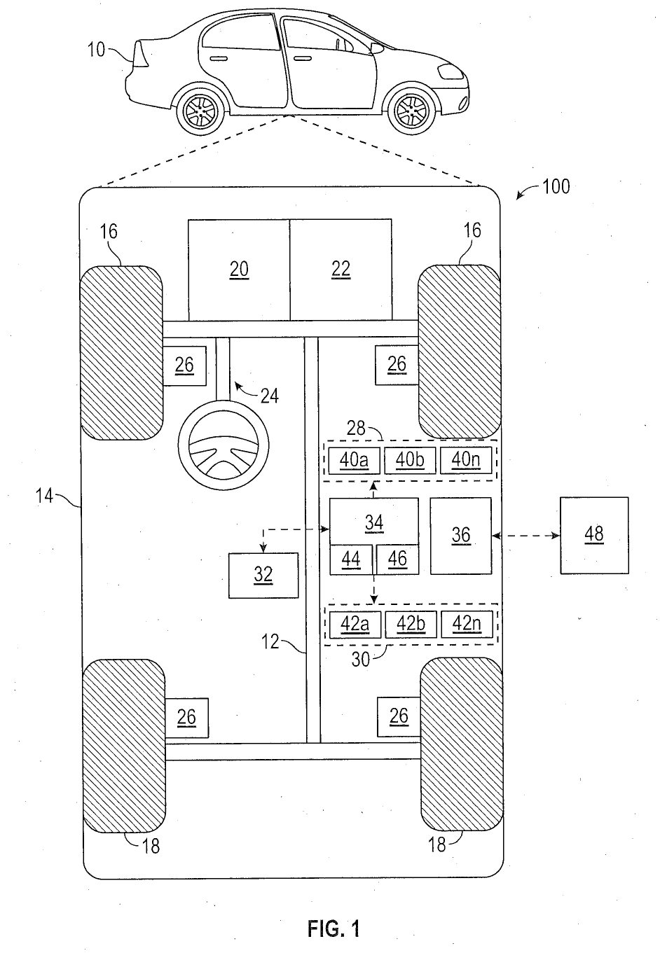

In accordance with an exemplary embodiment, FIG. 1 shows a vehicle 10 including an associated trajectory planning system shown generally at 100 in accordance with various embodiments. In general, the trajectory planning system 100 determines a trajectory plan for automated driving of the vehicle 10. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16 and 18 are each rotationally coupled to the chassis 12 near a respective corner of the body 14.

In various embodiments, the vehicle 10 is an autonomous vehicle and the trajectory planning system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16 and 18. The brake system 26 may, in various embodiments, include friction brakes, brake by wire, a regenerative braking system such as an electric machine, and/or other appropriate braking systems. The steering system 24 influences a position of the vehicle wheels 16 and 18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The cameras can include two or more digital cameras spaced at a selected distance from each other, in which the two or more digital cameras are used to obtain stereoscopic images of the surrounding environment in order to obtain a three-dimensional image. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the trajectory planning system 100 and, when executed by the processor 44, generates a trajectory output that addresses kinematic and dynamic constraints of the environment. In an example, the instructions received are input process sensor and map data. The instructions perform a graph-based approach with a customized cost function to handle different road scenarios in both urban and highway roads.

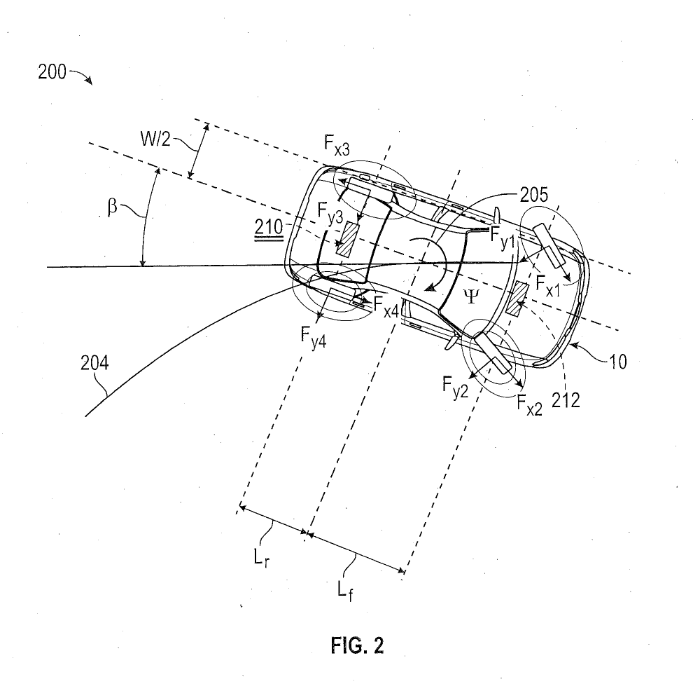

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The processor 44 further includes programs for operating the vehicle in at least one of two modes of operation; a standard mode of operation, and a performance mode of operation. In the standard mode of operation, the processor 44 operates a standard model of the vehicle that provides a linear relation between driver's inputs and vehicle dynamics. The standard model receives driver's inputs and determines a dynamic parameter of the vehicle based on the driver's inputs. The standard model generates actuator commands for the actuators of the vehicle and the processor 44 sends these command to the actuators in order to generate the dynamic parameter at the vehicle. A dynamic parameter in the standard mode can include a yaw rate of the vehicle, for example.

In the performance mode of operation, the processor 44 operates a performance model of the vehicle 10. The performance model is generally a non-linear model of the vehicle and generally takes in more input than the standard model in order to determine a dynamic parameter for the vehicle. For example, the standard model generally takes a driver's steering wheel angle as an input, while the performance model generally takes a tractive torque on a tire and a braking torque on the tire in addition to the steering wheel angle in order to determine the dynamic parameter. Thus, the performance model includes inputs from the accelerator pedal and brake pedal in addition to the steering wheel angle in order to define the dynamic states of the vehicle 10. The performance mode further uses several actuators that are not used in the standard mode of operation. Exemplary performance actuators used in the performance mode of operation include, but are not limited to electronically-limited slip differential actuator (eLSD) which controls a left-right torque distribution at the vehicle, an electronic All-Wheel Drive actuator (eAWD) which controls a front-back torque-distribution at the vehicle and a differential braking actuator (DB).

FIG. 2 shows a top view 200 of the vehicle 10 illustrating various forces on the vehicle during a maneuver. The vehicle 10 is shown moving along a selected trajectory 204. Tire forces (Fₓ₁, F_{y1}), (Fₓ₂, F_{y2}), (Fₓ₃, F_{y3}) and (Fₓ₄, F_{y4}) are shown for each of the tires. The yaw rate ψ is indicated by rotational arrow 205. Performance mode actuators are also shown. For example, the eLSD 210 is located between the rear wheels and controls a left-right torque distribution at the vehicle. The eAWD 212 is located between the front wheels and which controls a front-back torque-distribution at the vehicle. Another actuator, the Active-Aero actuator (not shown) helps to control the normal force on the tires of the vehicle 10.

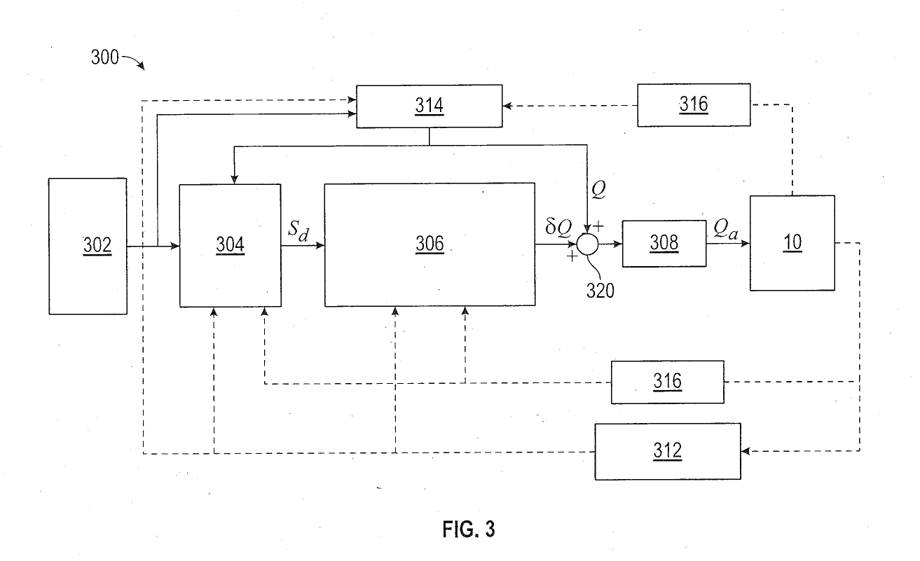

FIG. 3 shows a control structure 300 for operating the vehicle 10 in a driver-assisted mode. In various aspects, the control structure 300 includes various modules that operate on the processor 44 in order to translate a driver's intentions into actual motion of the vehicle. The control structure 300 includes a target state determination module 304, a vehicle control module 306, and actuators 308. The target state determination module 304 determines a desired state of the vehicle based on driver's inputs. The vehicle control module 306 determines a command control adjustment based on the desired state and operates actuators 308 in order to control the vehicle 10.

The control structure 300 receives driver's inputs 302, such as a steering wheel angle, a brake pedal position and an accelerator pedal position, from the driver. The driver's inputs 302 are provided to the target state determination module 304. The target state determination module 304 computes a desired state (S_{d}) based on the driver's inputs and provides the desired state S_{d} to the vehicle control module 306. The desired state S_{d} can include, but is not limited to, a desired yaw rate of the vehicle 10 and a desired side slip angle of the vehicle 10. The driver's inputs are also provided to a feedforward control module 314.

The vehicle control module 306 generates an actuator adjustment command (δQ) for the vehicle based on the desired state S_{d}. The actuator adjustment command δQ can be added to an actuator command (Q) that corresponds to the driver's inputs at summer 320. The actuator command Q is provided from the feedforward control module 314. The summation (Q+δQ) is provided to the actuators 308 in order to provide an action Qₐ that operates the vehicle 10. The actuators can include, for, the eLSD, the eAWD, a differential braking actuator (dB) and the Active-Aero actuator. The actuators are used to generate the desired states (e.g., yaw rate and side slip angle) at the vehicle 10. In various embodiments, the actuator commands can be adjusted to ensure that they do not exceed a capacity of either the tires of the vehicle or of the road.

The vehicle 10 thus undergoes the desired dynamic state, such as the desired yaw rate and/or the desired side slip angle. Sensors 316 on the vehicle 10 can detect these dynamic parameters and their values. In addition, a vehicle state estimate and fault detection module 312 can estimate the values of these dynamic parameters. The sensed values of these dynamic parameters and the estimated values of these dynamic parameters can be provided to the vehicle control modules 306 in order to help the vehicle control module 306 determine the command actuator adjustment δQ for a next time step of the vehicle control. Theses sensed and estimated values can also be provided to the target state determination module 304 in order to control calculation of the desired state S_{d}. Such feedback prevents the desired state Sa generated by the target state determination module 304 from changing too rapidly. The sensed values and estimated values can be further provided to the feedforward control module 314.

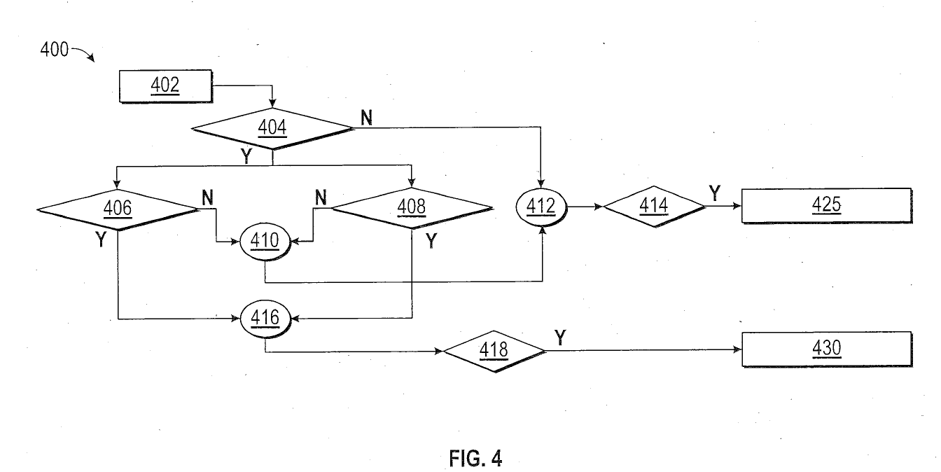

FIG. 4 shows a flowchart 400 for making a decision for selecting a mode of operation for the vehicle, i.e., selecting either the standard mode or the performance mode. In box 402, various inputs, such as lateral acceleration a_{y}, steering wheel angle δ and accelerator position p, are provided to the vehicle. The steering wheel angle δ and accelerator position p are driver's inputs while the lateral acceleration a_{y} is a dynamic parameter of the vehicle. Thresholds can be defined for each of these inputs based on manufacturer's specifications and other considerations.

In decision box 404, the lateral acceleration a_{y} of the vehicle is compared to the lateral acceleration threshold a_{y,th}. If the lateral acceleration is less than or equal to the lateral acceleration threshold (i.e., if a_{y}<=a_{y,th}), then the process flows to OR gate 412. Otherwise, if the lateral acceleration is greater than the lateral acceleration threshold (i.e., if a_{y}>a_{y,th}), then the method proceeds to boxes 406 and 408.

In decision box 406, the accelerator pedal position p is compared to a threshold pₜₕ(Vₓ) for the accelerator pedal position. The threshold pₜₕ(Vₓ) is a velocity-dependent threshold. The position threshold pₜₕ(Vₓ) is a function of a longitudinal speed of the vehicle. In decision box 408, the steering wheel angle δ is compared to a steering wheel angle threshold δ(Vₓ), which is also a function of the longitudinal speed of the vehicle.

Observing the combination of decision boxes 404, 406 and 408 as well as the logical decision boxes 410, 412, a decision can be made whether the vehicle is to be driven in standard mode or can be shifted from a performance mode to the standard mode. In particular, when the lateral acceleration does not exceed the lateral acceleration threshold (i.e., if a_{y}<=a_{y,th}), then via OR gate 412, a logical ‘true’ state is provided to decision box 414, which selects the standard mode of operation 425.

Alternatively, when the lateral acceleration exceeds the lateral acceleration threshold (i.e., if a_{y}>a_{y,th}), a test is made of the accelerator position and the steering wheel angle. When both of these parameters are less than their respective thresholds, the OR gate 410 and OR gate 412 combine to send a ‘true’ signal to decision box 414 in order to select the standard mode of operation 425. However, if each of the accelerator position and the steering wheel angle exceed their respective thresholds, then OR gate 416 provides a ‘true’ signal to logical decision box 418 that selects the performance mode of operation 430.

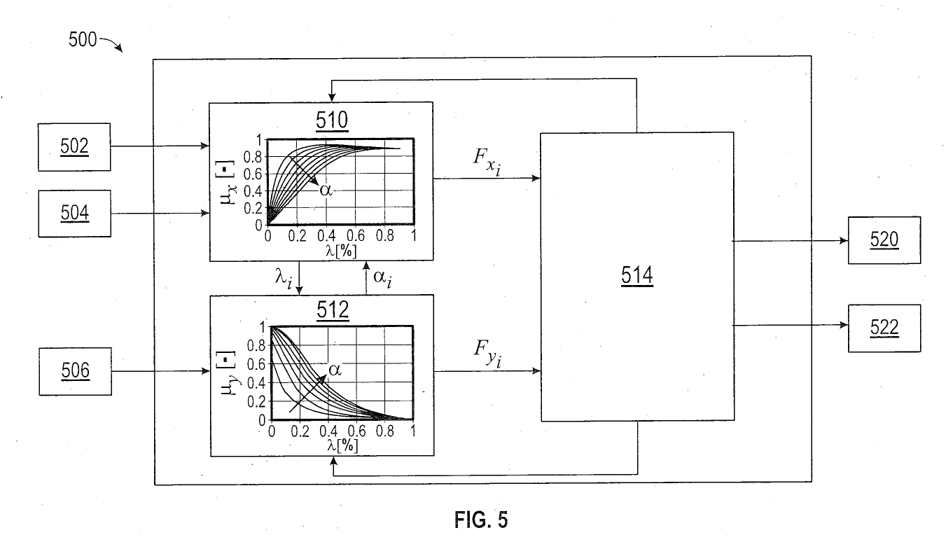

FIG. 5 shows a schematic diagram 500 illustrating a method for determining target states for performing driving or operation in a performance mode. The vehicle control module can receive at least one of a tractive torque 502, a braking torque 504 and a steering angle 506. The tractive torque 502 and the braking torque 504 are torques specifically related to the tires or wheels of the vehicle. The steering angle 506 can be related to vehicle rotation but also has an effect on tire dynamics. When operating in the standard mode, only the steering wheel angle 506 is used to estimate the desired vehicle responses. In the performance mode the tractive torque 502 and the braking torque 504 are included in calculations to determine the dynamic parameters of the vehicle.

The steering wheel angle 506 is provided to a wheel dynamics model 512 that relates lateral tire force to a stick-slip percentage of the tire in order to determine a lateral force F_{y} on the tire. The tractive torque 502 and braking torque 504 and are provided to a wheel dynamics model 510 that relates a longitudinal force to the stick-slip of the tire. The model 510 determines a longitudinal force Fₓ on the tire. Parameters from the model 510 can be provided to the model 512, and parameters from the model 512 can be provided to the model 510 in order to provide a combined stick-slip model.

Thus, in the performance mode, both the lateral forces and longitudinal forces are provided to a vehicle and actuator dynamics model 514 that determines a desired yaw rate 520 and desired lateral velocity 522 of the vehicle. The measured or estimated vehicle states can be provided from the vehicle and actuator dynamics model 514 to each of the wheel dynamics model 510 and the model 512.

Torques on the wheels can be determined using the following equations (1)-(4):

T_{ω1}=½(n_{f}T_{eAWD}−T_{br}_{₁}) Eq. (1)

T_{ω2}=½(n_{f}T_{eAWD}−T_{br}_{₂}) Eq. (2)

T_{ω3}=½(Tₐₓ_{ᵣ}−T_{eLSD}×sign(ω₃−ω₄))−T_{br}_{₃} Eq. (3)

T_{ω3}=½(Tₐₓ_{ᵣ}−T_{eLSD}×sign(ω₃−ω₄))−T_{br}_{₃} Eq. (4)

where

nᵣTₐₓᵣ=T_{drv}−n_{f}T_{eAWD} Eq. (5)

In equations (1)-(4), T_{wi} is the wheel torque on the i^{th} tire, T_{drv} is a driver-requested torque, Tₐₓᵣ is the rear axle torque, T_{bri} is the brake torque on the i^{th} tire, n_{f} is a differential gear ratio on the front and rear axles, ωᵢ is the angular velocity of the i^{th} wheel. The wheel having index i=1 is the front left wheel. The wheel having index i=2 is the front right wheel. The wheel having index i=3 is the rear left wheel, and the wheel having index i=4 is the rear right wheel. The results of the actuator dynamics model 514 can be provided to the wheel dynamics model 510 and 512 in order to help determine the forces on the tires.

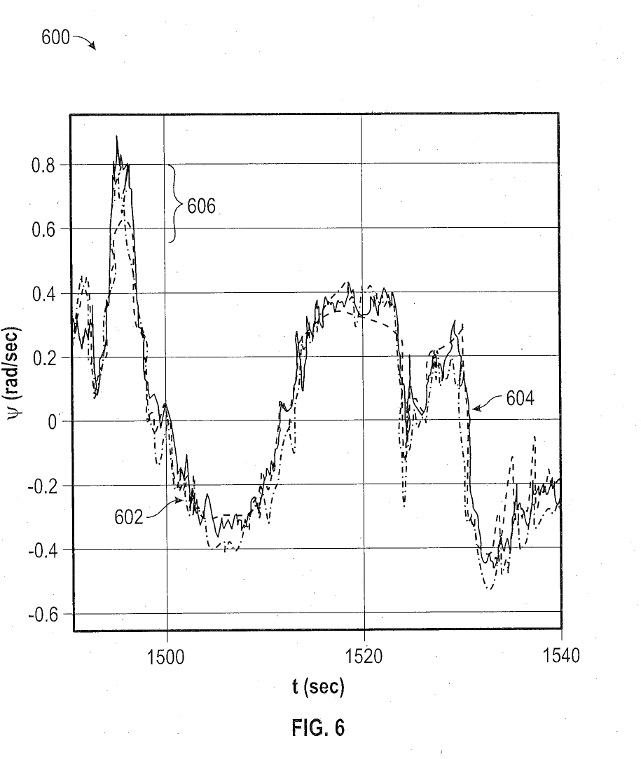

FIG. 6 shows a graph 600 comparing target yaw rates that can be achieved using standard models and performance models of the vehicle based on input to the respective models. In linear regions of operation, such as regions 602 and 604, there is very little difference between the yaw rate of the standard mode of operation and the yaw rate in the performance mode. However, at extreme yaw rates, such as at 606, there is a noticeable difference between the yaw rates. In other words, the performance mode can tolerate higher yaw rates than the standard mode and still remain stable.

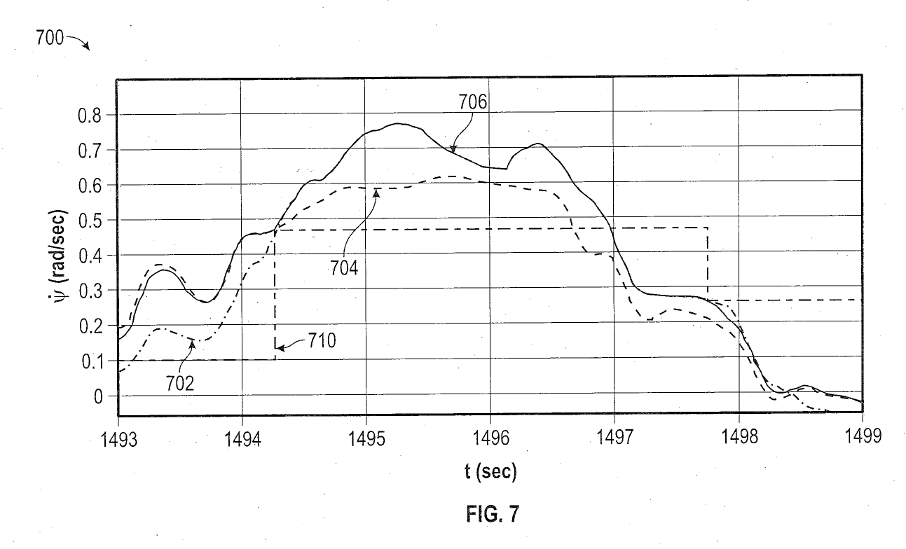

FIG. 7 shows a time graph 700 illustrating a switching of the vehicle between a standard mode and performance mode using the decision methods disclosed herein with respect to FIG. 4. Yaw rate is shown along the ordinate axis with time shown along the abscissa. The target yaw rate calculated for the performance mode is indicated by curve 702, while the target yaw rate calculated for the standard mode is indicated by curve 704. The yaw rate for the actual mode of operation of the vehicle switches between the standard yaw rate and performance yaw rate. The actual yaw rate of the vehicle is shown by curve 706. Prior to about t≈1494.2 seconds, the yaw rate for the performance mode is less than then yaw rate for the standard mode. Thus, before t≈1494.2 seconds, the actual yaw rate of the vehicle determine by the standard model for the vehicle, as indicated by the relative agreement between curve 704 and 706 in this time range. However, at t≈1494.2 the yaw rate for the performance mode exceeds the yaw rate of the standard mode. At t≈1494.2 seconds, the vehicle switches from the standard mode to the performance mode.

The switch from the standard mode to the performance mode is indicated by an upward step in line 710. From about t≈1494.2 second to about t≈1497.7 seconds, the vehicle operates in the performance mode, as seen by the relative agreement between curve 706 and curve 702 over this time range. At about t≈1497.7 seconds, the decision process of FIG. 5 causes the vehicle to shift back into the standard mode, as seen by the downward step in line 710. After about t≈1497.7 seconds, the actual yaw rate mode gradually shifts back into agreement with the yaw rate of the standard mode, as seen as the actual yaw rate 706 returning to match the standard yaw rate 702.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating a performance vehicle, comprising:
detecting a driver input at the vehicle;
comparing a value of the driver input to a threshold value for the driver input;
switching to a performance mode of operation for the vehicle when the value of the driver input is greater than the threshold value;
generating a command at the vehicle based on the value of the driver input using a performance model of the vehicle activated in the performance mode; and
activating a performance actuator of the vehicle to generate a dynamic parameter at the vehicle from the command.

2. The method of claim 1, wherein the driver input comprises at least one of an accelerator pedal position and a brake pedal position.

3. The method of claim 2, wherein the driver input further comprises a steering wheel angle.

4. The method of claim 1, further comprising switching to the performance mode of operation when a lateral acceleration, a brake pedal position and a steering wheel angle exceed their respective threshold values.

5. The method of claim 4, further comprising switching to a standard mode of operation of the vehicle when one of: (i) a lateral acceleration is less than a lateral acceleration threshold value; and (ii) the brake pedal position is less than a brake pedal position threshold and the steering wheel angle is less than a steering wheel angle threshold.

6. The method of claim 1, wherein the dynamic parameter is at least one of a desired yaw rate and a desired side slip angle at the vehicle.

7. The method of claim 1, further comprising determining the dynamic parameter of the vehicle in the performance mode using a tractive torque on a tire related to the accelerator pedal position and a braking torque on the tire related to the brake pedal position.

8. A system for operating a vehicle, comprising:
a sensor for detecting a value of driver input to the vehicle; and
a processor configured to:
compare the value of the driver input to a threshold value for the driver input,
switch to a performance mode of operation for the vehicle when the value of the driver input is greater than the threshold value,
generate a command at the vehicle based on the value of the driver input using a performance model of the vehicle activated in the performance mode, and
activate a performance actuator of the vehicle to generate a dynamic parameter at the vehicle from the command.

9. The system of claim 8, wherein the driver input comprises at least one of an accelerator pedal position and a brake pedal position.

10. The system of claim 9, wherein the driver input further comprises a steering wheel angle.

11. The system of claim 8, wherein the processor is further configured to switch to the performance mode of operation when a lateral acceleration, a brake pedal position and a steering wheel angle exceed their respective threshold values.

12. The system of claim 11, wherein the processor is further configured to switch to a standard mode of operation of the vehicle when one of: (i) the lateral acceleration is less than a lateral acceleration threshold value; and (ii) the brake pedal position is less than a brake pedal position threshold and the steering wheel angle is less than a steering wheel angle threshold.

13. The system of claim 8, wherein the dynamic parameter is at least one of a desired yaw rate and a desired side slip angle at the vehicle.

14. The system of claim 8, further comprising determining the dynamic parameter of the vehicle in the performance mode using a tractive torque on a tire related to the accelerator pedal position and a braking torque on the tire related to the brake pedal position.

15. A vehicle, comprising:
a sensor for detecting a value of driver input to the vehicle; and
a processor configured to:
compare the value of the driver input to a threshold value for the driver input,
switch to a performance mode of operation for the vehicle when the value of the driver input is greater than the threshold value,
generate a command at the vehicle based on the value of the driver input using a performance model of the vehicle activated in the performance mode, and
activate a performance actuator of the vehicle to generate a dynamic parameter at the vehicle from the command.

16. The vehicle of claim 15, wherein the driver input comprises at least one of an accelerator pedal position and a brake pedal position.

17. The vehicle of claim 16, wherein the driver input further comprises a steering wheel angle.

18. The vehicle of claim 15, wherein the processor is further configured to switch to the performance mode of operation when a lateral acceleration, a brake pedal position and a steering wheel angle exceed their respective threshold values.

19. The vehicle of claim 19, wherein the processor is further configured to switch to a standard mode of operation of the vehicle when one of: (i) the lateral acceleration is less than a lateral acceleration threshold value; and (ii) the brake pedal position is less than a brake pedal position threshold and the steering wheel angle is less than a steering wheel angle threshold.

20. The vehicle of claim 15, wherein the dynamic parameter is at least one of a desired yaw rate and a desired side slip angle at the vehicle.
